(19) United States
(12) Patent Application Publication
(10) Pub. No.: US 2006/0201759 A1
(43) Pub. Date: Sep. 14, 2006

(54) Isolation cabinet

(75) Inventors: Gerald J. Spyche JR., South Wales, NY (US); Kenichi Tomita, Williamsville, NY (US)

Correspondence Address: WALL MARJAMA & BILINSKI, 101 SOUTH SALINA STREET, SUITE 400, SYRACUSE, NY, 13202, US

(73) Assignee: Enidine, Inc., Orchard Park, NY (US)

(21) Appl. No.: 11/078,104

(22) Filed: Mar. 11, 2005

(51) Int. Cl. F16D 51/60

(52) U.S. Cl. 188/136

(57) ABSTRACT

A cabinet for reducing the G-loading upon a delicate instrument produced by shock and vibratory forces. The cabinet includes an inner frame and an outer frame that are co-joined by a series of horizontal isolators and double acting isolator or shock absorber assemblies.

### STATEMENT REGARDING FEDERALLY SPONSORED RESEARCH

This invention was made with Government support under contract number NO0167-01-D-0063 awarded by Naval Surface Warfare Center Carderock Division.

### FIELD OF THE INVENTION

This invention relates to a cabinet for reducing the G-loading on sensitive instruments stored in the cabinet that are produced by shock or vibratory forces.

### BACKGROUND OF THE INVENTION

A shock and vibration isolation system is disclosed in U.S. Pat. No. 6,530,563 B1. The disclosed system includes a cabinet having an inner frame for supporting sensitive instruments that is mounted within an outer frame. Each frame is rectangularly shaped with the side walls of the inner frame being adjacent to and parallel with the side walls of the outer frame. Two opposed side walls of the inner frame are connected to the adjacent side walls of the outer frame by a series of wire rope isolators. The wire rope isolators are mounted so that each can slide freely in a vertical direction. A pair of double acting shock absorbers are also connected between each of the adjacent side walls of the inner and outer frames so that the shock absorbers can deflect in a vertical direction. The shock absorbers and the wire rope isolators combine to effectively attenuate shock and vibration forces moving along the vertical, horizontal and longitudinal axes of the system.

As will become apparent from the disclosure below, the present invention represents a further improvement in the isolation cabinet disclosed in the above noted '563 patent. The improvement is realized by relocating the wire rope or other horizontal isolators into positions where they can more effectively attenuate shock and vibratory forces moving in both the horizontal and longitudinal directions. This is accomplished by locating these horizontal isolators so that they will deflect in the same mode, whether the input is from the horizontal, longitudinal, or any combination of the two directions. This is an improvement over prior art systems because it allows the system to be mounted with no restrictions on orientation with respect to these directions. The isolator assemblies for attenuating shock and vibration in the vertical direction can be any double acting shock absorber, such as those referenced in the above noted '563 patent, that is capable of supporting the inner cabinet weight and can include both mechanical and liquid spring units that work together to more effectively attenuate shock and vibratory forces acting in a vertical direction. The isolator assemblies are arranged to attenuate shock and vibratory forces to lower G-load levels acting upon the inner frame of the cabinet.

### SUMMARY OF THE INVENTION

It is therefore an object of the present invention to improve cabinets for protecting sensitive instruments against the harmful effects of shock and vibratory input forces.

It is a further object of the present invention to lower the G-loads on sensitive instruments produced by relatively high shock and vibratory input forces.

These and other objects of the present invention are attained by an isolation cabinet that includes an inner frame that is supported within an outer frame by a series of horizontal isolators and double acting shock absorber or isolator assemblies. The frames are generally rectangular shaped with the vertical corners of the inner frame being located adjacent to and parallel with the vertical corners of the outer frame. Each corner has a plate that extends vertically along the length of the frame and which is placed at a 45° angle with respect to the sides of the frame that form the corner. The horizontal isolators are mounted between the corner plates on slides so that they can move freely in a vertical direction. In one embodiment of the invention, double acting isolator assemblies each include a mechanical spring that acts in parallel with a liquid spring. The assemblies are mounted in pairs between adjacent sides of the frames so that the assemblies can deflect in a vertical direction.

### BRIEF DESCRIPTION OF THE DRAWINGS

For a further understanding of these and objects of the present invention, reference will be made to the following Detailed Description which is to be read in conjunction with the accompanying drawings, wherein:

FIG. 1 is a perspective view of an isolator cabinet that embodies the teachings of the present invention for protecting sensitive instruments from high G-load produced by shock and vibratory forces;

FIG. 2 is a side elevation of the cabinet of FIG. 1 with some components removed for the sake of clarity;

FIG. 3 is a sectional view taken along lines 3-3 in FIG. 2;

FIG. 4 is a enlarged view further illustrating the corer mounting arrangement of an isolator;

FIG. 5 is an enlarged perspective view of an exemplary isolator unit utilized in the practice of the present invention;

FIG. 6 is a side elevation illustrating an exemplary double acting isolator assembly utilized in the practice of the present invention;

FIG. 6A is an enlarged partial view in section showing an end section of the spring assembly;

FIG. 6B is an enlarged partial view showing the center section of the spring assembly;

FIG. 6C is an enlarged partial view showing a flanged cylinder for separating springs in the mechanical spring array;

FIG. 7 is an enlarged partial top view illustrating the bottom portion of the isolator assembly;

FIG. 8 is a section taken along lines 8-8 of FIG. 7;

FIG. 9 is a partial sectional view illustrating the mounting of a piston within the liquid spring used in the isolator assembly; and

FIG. 10 is a schematic diagram showing the liquid springs control circuitry.

### DETAILED DESCRIPTION

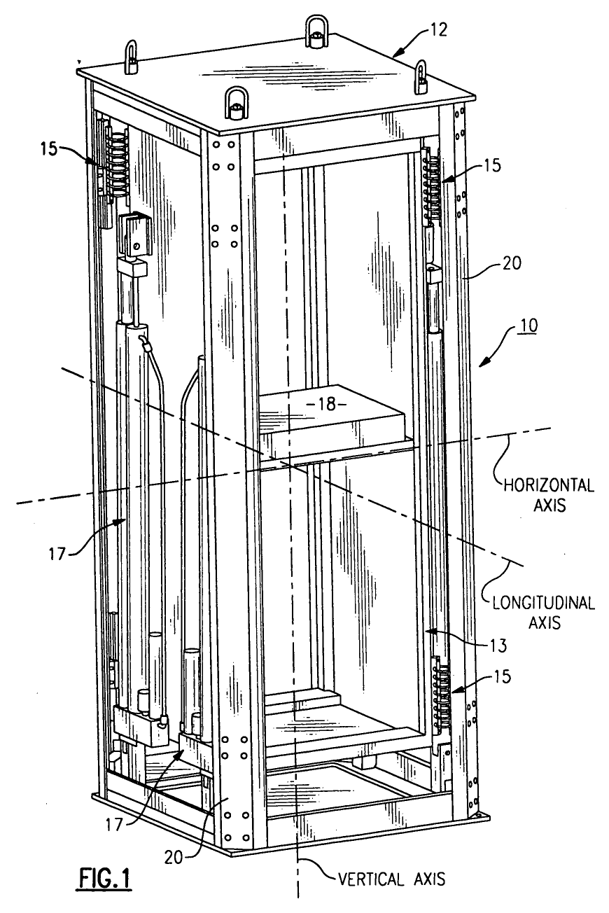

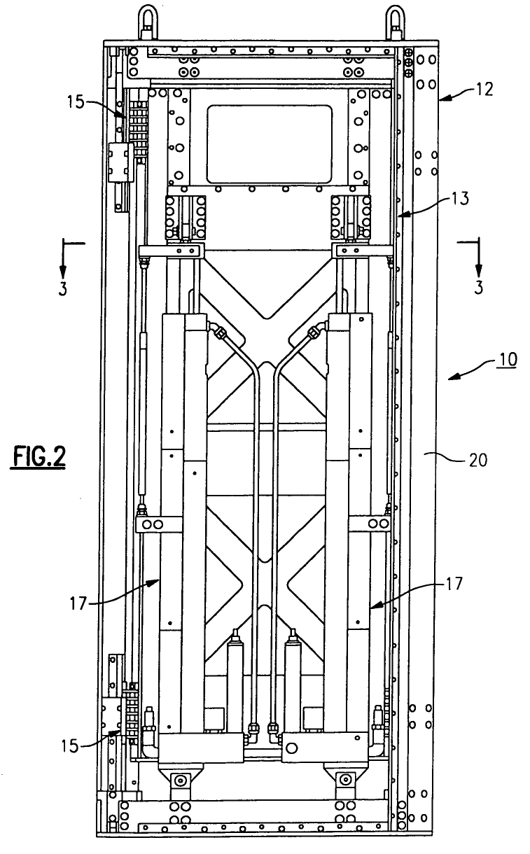

With initial reference to FIGS. 1-5, the present invention will be described with reference to a cabinet generally depicted 10, for protecting sensitive instruments, such as computers and the like, from high G-loads caused by shock or vibratory input forces. The cabinet 10 contains an outer frame 12 that is affixed to a main structure or ground and is thus exposed to seismic events. The cabinet 10 further includes an inner frame 13 that is suspended within the outer frame 12 by a plurality of wire rope isolators 15 and a series of isolator assemblies 17 that act in concert to reduce the G-loads acting upon the cabinet to levels such that a sensitive instrument 18 (FIG. 1) that is stored in the inner frame 13 will not be harmed and will continue to operate in the event of a high cyclic input force.

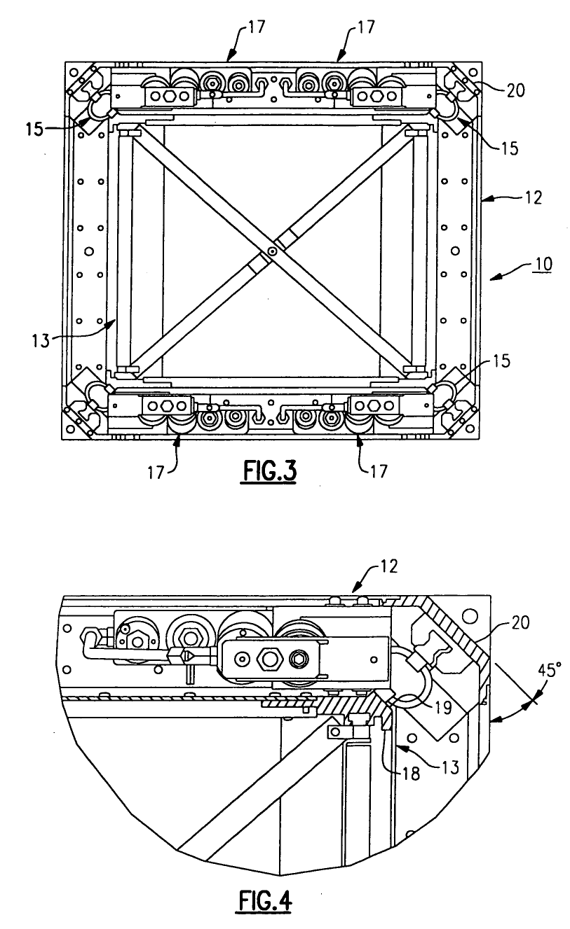

The inner and outer frames 12, 13 of the cabinet 10 are generally rectangular structures that share a common vertical axis so that the vertical comers of the inner frame are situated adjacent to those of the outer frame. As best illustrated in FIG. 4, a vertical plate 19 is located at each vertical corner of the inner frame 13 with the plate forming an angle of about 45° with the adjacent sides of the frame. Similarly, the adjacent vertically disposed corners of the outer frame 12 each contain a plate 20 that also forms an angle of about 45° with the adjacent sides of the outer frame. The adjacent plates 19, 20 are in parallel alignment with a gap separating the plates.

With further reference to FIG. 5, each wire rope isolator 15 includes a pair of opposed blocks 21 and 22 with a wire rope 23 being threaded through the blocks and locked in place by crimping the block securely against each of the rope loops. Other means for locking the rope 23 to the blocks 21, 22, such as set screws or the like, may also be employed. One of the blocks 22 is secured to a slide member 24 that is slidably contained within a guideway 25. The opposite block 21 is secured to one of the corner plates which in this case is plate 19, while the guideway 25 is affixed to an adjacent plate 20 so that the wire rope isolator 15 can move freely in a vertical direction within the gap separating the adjacent plates between the frames. In the assembly, the wire rope isolators 15 are mounted between the adjacent corners of the frames at the bottom and the top sections of the plates 19, 20. However, the number of wire rope isolators in each gap may vary depending upon the specific application. A wire rope isolator suitable for use in the present embodiment of the invention is described in greater detail in U.S. Pat. No. 5,549,285, the disclosure of which is incorporated herein by reference. It should be noted herein that other horizontal isolators in lieu of the wire rope isolators, such as, for example elastomeric isolators, may also be employed in a similar manner and are intended to fall within the scope of the present invention.

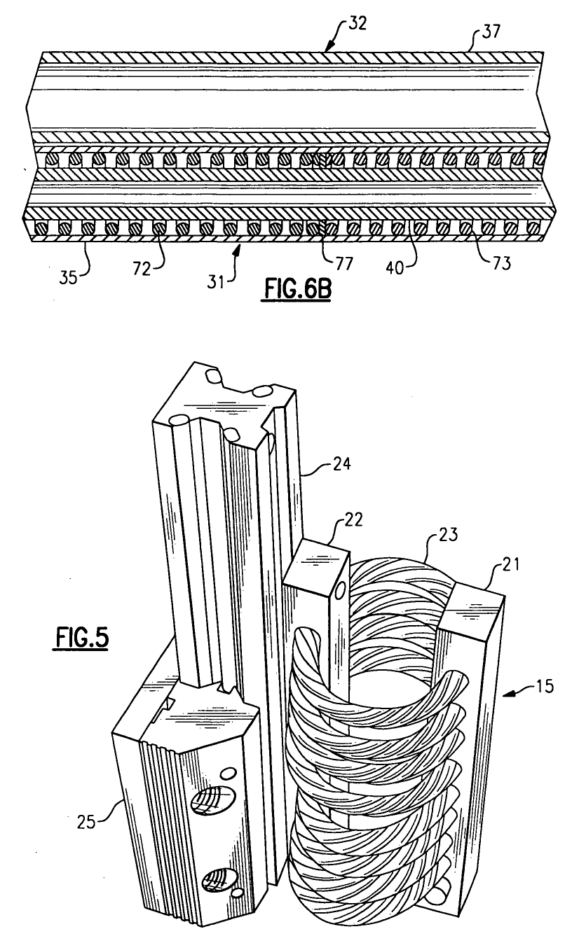

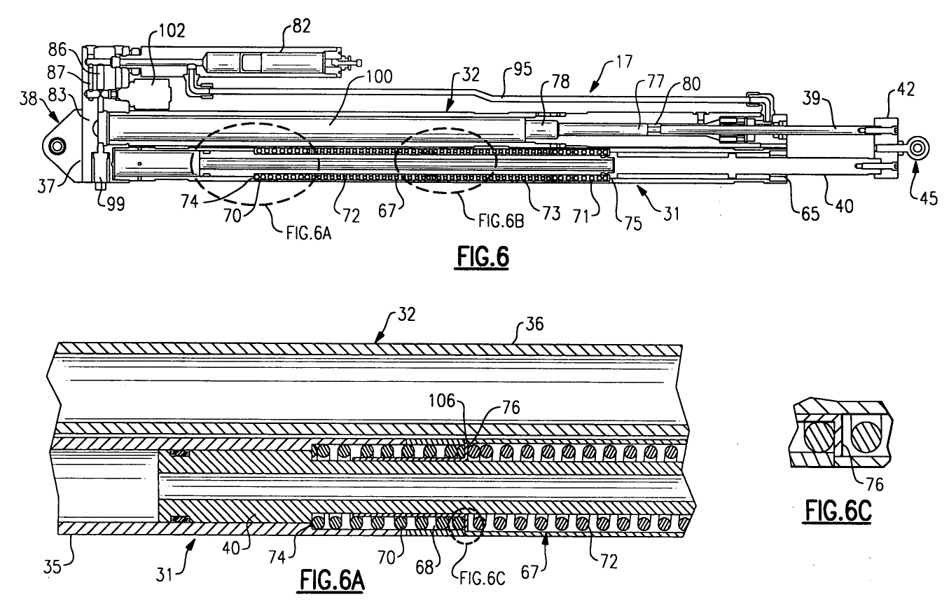

Four isolator assemblies 17 are also arranged to act between the inner and outer frames 12, 13 of the instrument cabinet 10. Each assembly 17 includes a mechanical spring unit 31 and a fluid spring unit generally referenced 32 (FIG. 6) that are vertically mounted in a side by side relationship between the two frames. The mechanical spring unit 31 is contained within a cylindrical sleeve 35 while the fluid spring unit 32 is contained within a cylindrical fluid tight housing 36. The lower section of each housing is secured to a base 37 which in turn, is affixed to the lower part of one of the frames of the cabinet 10 by a first connector 38. A piston rod 39 extends upwardly from the upper end of the fluid spring unit 32 in parallel alignment with an elongated linear arm 40 that passes upwardly from the upper end of the mechanical spring unit 31. The piston rod of the fluid spring unit 32 and the linear arm of the mechanical spring unit 31 are tied together by a common yoke 42. The yoke 42, in turn, is attached to the other frame by a second connector 45. As will be explained in greater detail below, the piston rod 39 and the linear arm 40 are forced to move together in unison as the shock and vibration isolator unit is stroked in a vertical direction.

As noted above, the double acting mechanical spring unit 31 is contained within a tubular shell 35. The linear arm 40 is slidably mounted in the central bore of the sleeve 65 to establish a close sliding fit between the sleeve and the arm. An array 67 of four compression springs are wound in series about the arm 40. The spring array 67 resides within a recess 68 that is shared equally between the inner wall of the shell and the outer wall of the arm 40 when the assembly is not moved in either compression or tension. The array 67 includes a pair of outer ends comprising a compression side end spring 70 and a tension side end spring 71 which are spaced apart by two inner springs 72 and 73. When in the neutral position, the compression side end spring 70 rests against one end shoulder 74 of the recess 68 and the tension side end spring 71 rests against the opposite shoulder 75 of the recess 68. The springs are arranged to provide a range of preloads based on the dynamics of the system when the assembly is in the neutral or unstressed position.

In this embodiment of the invention, the two side end springs 70 and 71 of the spring array 67 have the same spring rate as do the two inner springs 72 and 73. The spring rate of the side end springs 70, 71 is typically higher than that of the inner springs 72, 73. The preload of the inner springs 72 and 73 is much higher than the preload of the side end springs 70 and 71. Each side end spring 70, 71 is separated from the adjacent inner springs 72, 73 by a flanged cylinder 76 that extends inwardly into a recess formed in the shell 35. The flanged part of each cylinder 76 is arrested on a shoulder formed in the shell 35 which permits the cylinder 76 to move only toward the inner spring. The depth of penetration of each cylinder 76 is slightly less than the depth of the upper half of the recess which is formed by the shell, thus allowing the shell to move freely over the linear arm 40. The two inner springs 72 and 73 are similarly separated by a center ring 77 (FIG. 6B).

When the outer frame 12 of the cabinet 10 is exposed to a shock or vibratory load that is greater than the spring preload, the shell is initially driven upwardly over the linear arm 40 toward the inner frame 13. As a result, the tension side end spring 71 is compressed between the flanged cylinder 76 and the shoulder of the recess 106 formed in the shell on the tension side of the recess. In this case, the tension side of the spring array 67 is on the right side of the isolator illustrated in FIG. 6 and the compression side is on the left side of the isolator. At this time, the compression side end spring 70 remains in its initial preload position captured between the shoulder 106 formed in the upper half of the recess on the compression side of the system and the adjacent compression side flanged cylinder 76.

The tension side end spring 71, having a higher spring rate than the inner springs 72 and 73, is arranged so that it will resist the initial compressive load until the shell has been displaced a first distance toward the tension side of the assembly, whereupon the tension side spring is completely depressed. At this time, the inner springs 72 and 73, which have a lower spring rate, take over the compressive load thereby storing addition energy toward the end of the compression stroke, but at the lower spring rate to considerably reduce the G forces transmitted to the inner frame 12 of the cabinet 10.

At the end of the compression cycle, the mechanical spring unit 31 will go into a tension mode of operation as the frames return to their original preloaded condition positions. As noted above, the mechanical spring unit 31 is a double acting unit and because the springs in the array 67 are arranged symmetrically about the center of the array, the assembly will respond in the same manner in both the compression and tension modes of operation. Accordingly at the beginning of the tension mode, the compression side end spring 70 will initially provide a stiff resistance to the rebound forces until such time as the end spring is fully compressed whereupon, the softer inner spring 72 and 73 stores the load energy to reduce the G forces acting upon the inner frame. Although the end springs in this example have a higher spring rate than the inner springs, the spring rate of the end springs may be made lower than that of the inner springs without departing from the teachings of the invention.

The liquid spring unit 32 includes a cylindrical housing 36 that contains a central bore having three chambers of varying diameters. The larger diameter chamber 100 is located at the compression side of the housing 36 and is connected to the small diameter chamber 77 by an intermediate diameter chamber 78. A piston 80 is slidably contained within the smaller diameter chamber 77 and is attached to piston rod 39. The length of the small diameter chamber 77 is slightly greater than the stroke of the mechanical spring unit 31, thus enabling the two spring assemblies to move together in unison to attenuate the vibratory G forces acting in both directions upon the system. The three chambers 77, 78, 100 are arranged so as to tune the natural frequency of the liquid spring far enough away from that of the inner frame 13 and equipment mass so that the two frequencies cannot combine to produce a deleterious effect upon the system.

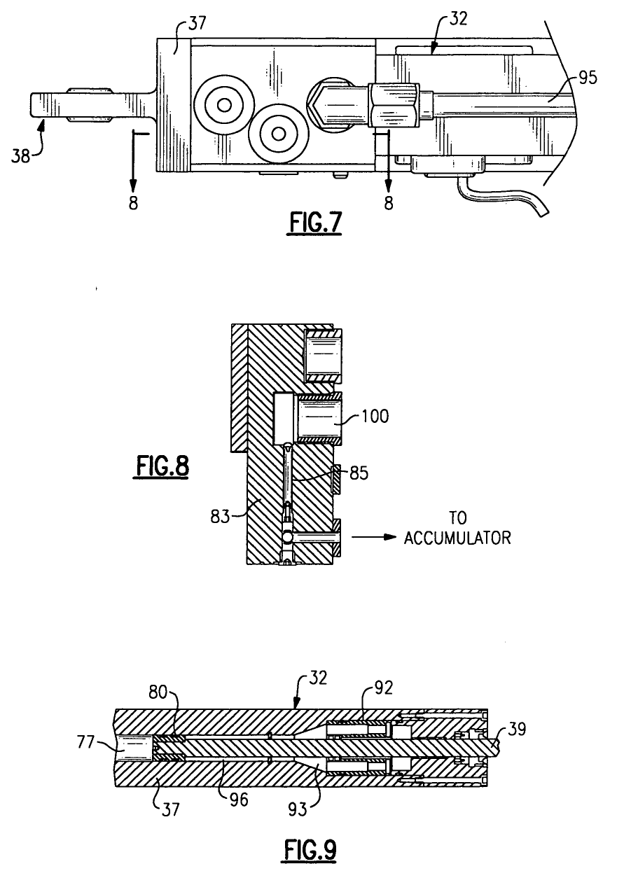

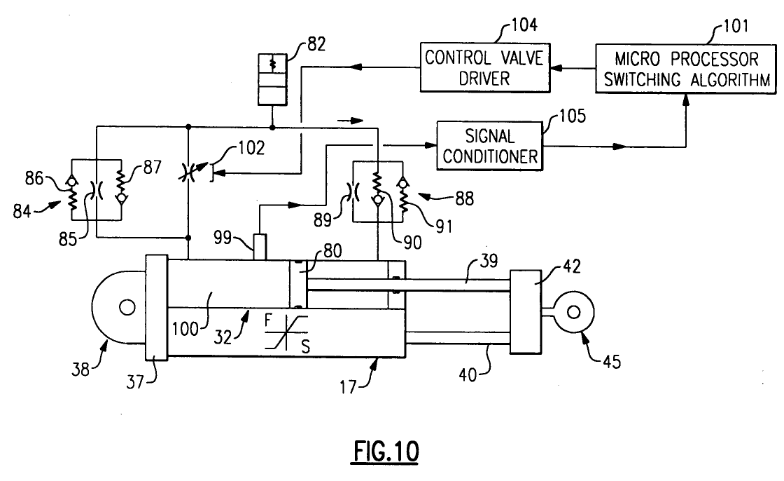

The function of the liquid spring unit 32 will be explained in greater detail with further reference to the diagram illustrated in FIG. 10 and FIGS. 7-9. The large diameter chamber 100 on the compression side of the liquid spring housing is connected to an accumulator 82 by means of a manifold 83 that contains a compression side flow control circuit generally referenced 84 (see FIG. 10). The control circuit 84 contains an orifice 85 that is adapted to orifice fluid from chamber 100 back to the accumulator 82 in the event the pressure in the chamber 100 exceeds a predetermined level during the compression cycle. A refill check valve 86 is placed in parallel over the control orifice 85 and is arranged to open when the fluid pressure in the accumulator 82 exceeds that in the large diameter chamber 100 which occurs when the liquid spring unit 32 changes from the compression mode of operation over to the tension mode of operation, the latter keeping the compression side of the bore filled with fluid during the tension cycle. A relief check valve 87 is also mounted in parallel with the control orifice 85 and the refill check valve 86 and is arranged to open in the event the isolator experiences an exceedingly high input force. Opening the relief valve releases the liquid spring unit 32 from the system and thus helps to reduce the adverse effect of the exceedingly high input load on the inner frame structure.

The accumulator 82 is also connected to the smaller diameter chamber 77 by a second flow control circuit 88 that includes a flow control orifice 89, a refill check valve 91 and a relief check valve 90. During the tension cycle, the flow orifice 89 conveys fluid back from the small diameter chamber 77 to the accumulator 82 when the pressure behind the piston is greater than that in the accumulator. The refill check valve 91, in turn, is arranged to open when the fluid pressure in the accumulator 82 exceeds the fluid pressure behind the piston so that fluid flow into the smaller chamber during the compression mode continues to fill the area behind the piston. The relief check valve 90 again is arranged to open in the event the G loading on the isolator exceeds a given limit, thereby completely releasing the liquid spring from the system.

The valve components of the second flow control circuit 88 are mounted in a cartridge 92 that is located in a cavity 93 behind the smaller diameter chamber 77. The cavity 93 is placed in fluid flow communication with the accumulator 82 by a flow line 95 and with the smaller chamber 77 of the liquid spring unit 32 by means of a conduit 96 (FIG. 9). The piston rod 39 is arranged to move axially in the cartridge 92 and suitable seals are provided to prevent fluid flow passing between the cartridge and the piston rod.

A pressure transducer 99 is mounted in the large diameter chamber 100 of the liquid spring unit 32 on the compression side of the piston 80 which measures the pressure in the chamber and transmits a signal indicative of the pressure to a signal conditioner 105. A conditioned output signal is sent from the conditioner to a microprocessor 101 that contains a switching algorithm for controlling a control valve 102 through a control valve driver 104. In response to the algorithm, the valve 102 is cycled to maintain a desired pressure on the compression side of the liquid spring unit 32 and thus limit the G loading on the inner frame 12 during the compression cycle.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A cabinet for reducing the G-loading experienced by delicate instruments that is produced by shock and vibratory forces, wherein said cabinet comprises:
an outer frame secured to ground and an inner frame suspended inside said outer frame by a series of horizontal isolators;
means for securing each of the horizontal isolators to one of said frames and slidably connecting each horizontal isolator to the other of said frames so that each said horizontal isolator can move freely in a vertical plane;
at least one of a double acting isolator assembly and a double acting shock absorber assembly connected at one end to said inner frame and at the other end to said outer frame so that said assembly can deflect in said vertical plane, said inner and the outer frames being rectangular in form, said inner frame having four vertically disposed corner pieces that are located adjacent to and parallel with corner pieces on the other frame, each of said vertically disposed corner pieces being set at a 45° angle with regard to adjacent sides of the frame and at least one horizontal isolator being connected to each adjacent pair of corner pieces.

2. The cabinet of claim 1, wherein a plurality of horizontal isolators are mounted between each of the adjacent corner pieces.

3. The cabinet of claim 2, wherein horizontal isolators are mounted at the top section, middle section, and the bottom section of each adjacent corner pieces.

4. The cabinet of claim 2, wherein each horizontal isolator includes a pair of spaced apart mounting blocks that are connected by an isolating material, wherein one mounting block is secured to a first corner piece and the other mounting block is slidably connected to a second adjacent corner piece.

5. The cabinet of claim 4, wherein said other mounting block is secured to a slide member which is slidably contained within a guideway which is secured to said second adjacent corner piece.

6. The cabinet of claim 1, wherein said cabinet includes at least one double acting isolator assembly, said at least one double acting isolator assembly including a mechanical spring section that is arranged to act in parallel with a liquid spring section.

7. The cabinet of claim 6, that further includes a flow control means for regulating the flow of a fluid between the liquid spring section and an accumulator.

8. The cabinet of claim 7, wherein the mechanical spring section has a first spring rate when deflected over a first distance and a second spring rate when deflected a further distance that is greater than the first distance.

9. The cabinet of claim 8, wherein said first spring rate is higher than said second spring rate.

10. The cabinet of claim 9, wherein said flow control means contains a control valve for maintaining the pressure on at least one of the compression side and the tension side of the liquid spring section at a desired level.

11. The cabinet of claim 10, wherein said flow control means further includes a relief valve for reducing the pressure in said liquid spring section in the event the pressure exceeds a given value.

12. The cabinet of claim 1, including a first series of isolator assemblies connected between first adjacent sides of the frames and a second series of assemblies, said second series comprising one of a series of double acting isolator assemblies and double acting shock absorber assemblies connected between opposing adjacent sides of the frames.

13. The cabinet of claim 1, wherein at least one of the isolators and the double acting assemblies are arranged to support the weight of the inner frame.
